(19) United States
(12) Patent Application Publication
(10) Pub. No.: US 2020/0010095 A1
(43) Pub. Date: Jan. 9, 2020

(54) METHOD AND APPARATUS FOR MONITORING DRIVING CONDITION OF VEHICLE

(71) Applicant: LG ELECTRONICS INC., Seoul (KR)

(72) Inventor: Soryoung KIM, Seoul (KR)

(73) Assignee: LG ELECTRONICS INC., Seoul (KR)

(21) Appl. No.: 16/578,212

(22) Filed: Sep. 20, 2019

(30) Foreign Application Priority Data
Aug. 30, 2019 (KR) 10-2019-0107597

(51) Int. Cl. B60W 50/14; G05D 1/00; B60W 30/18; B60W 10/04; B60W 10/20

(52) U.S. Cl. CPC B60W 50/14; G05D 1/0088; B60W 30/18; B60W 10/04; B60W 10/20; B60W 2050/0071; B60W 2510/20; B60W 2520/10; B60W 2720/106; B60W 2710/20; G05D 2201/0213

(57) ABSTRACT

The present disclosure relates to a method of monitoring the driving state of a vehicle. The method includes acquiring driving information of a vehicle, identifying, based on the acquired driving information, whether the vehicle satisfies at least one condition in a predetermined section, identifying a verification type corresponding to the satisfied condition, and identifying a driving state of the vehicle based on the verification type. One or more of an autonomous vehicle and a crime prediction device of the present disclosure may be connected to, for example, an artificial intelligence module, an unmanned aerial vehicle (UAV), a robot, an augmented reality (AR) device, a virtual reality (VR) device, or a 5G service device.

### CROSS-REFERENCE TO RELATED APPLICATION

Pursuant to 35 U.S.C. § 119(a), this application claims the benefit of earlier filing date and right of priority to Korean Patent Application No. 10-2019-0107597, filed on Aug. 30, 2019, the contents of which are hereby incorporated by reference herein in its entirety.

### BACKGROUND

### 1. Field

The present disclosure relates to a method of monitoring, by a computation device, the driving state of a vehicle which is under manual driving and more particularly, relates to a method and apparatus of controlling driving of a vehicle by identifying a verification type based on driving information of a vehicle and verifying the driving state of the vehicle based on an identification result.

### 2. Description of the Related Art

When a situation in which a vehicle that is under autonomous driving needs to be manually driven occurs or when a driver tries to drive a vehicle, the vehicle may be switched from autonomous driving to manual driving. While the vehicle is under manual driving, a risk factor for each driver may be identified with relation to driving of the vehicle. This is because driver's proficiency may vary or differ according to a driving time, a driving area, or driving experience. Therefore, it may be necessary to monitor whether there is a risk factor with relation to driving of the vehicle switched from autonomous driving to manual driving and to control driving of the vehicle having a risk factor.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Embodiments of the present disclosure are proposed to address the above description, and disclose a technology of controlling driving of a vehicle by identifying a verification type based on driving information of the vehicle and verifying the driving state of the vehicle based on an identification result. Technical subjects to be achieved by the embodiments are not limited to the above-described technical subject, and other technical subjects may be analogized from the following embodiments.

To achieve the above-described subject, according to one embodiment of the present disclosure, a driving state monitoring method, performed by a vehicle, may include acquiring driving information of the vehicle, determining, based on the acquired driving information, whether the vehicle satisfies at least one condition in a predetermined section, identifying a verification type corresponding to the satisfied condition, and verifying a driving state of the vehicle based on the verification type.

According to another embodiment of the present disclosure, a vehicle may include a display and a processor configured to acquire driving information of the vehicle, determine, based on the acquired driving information, whether the vehicle satisfies at least one condition in a predetermined section, identify a verification type corresponding to the satisfied condition, and verify a driving state of the vehicle based on the verification type.

Details of other embodiments are included in the following detailed description and the drawings.

One or more effects according to the embodiments of the present disclosure are as follows.

First, by monitoring the driving state of a vehicle which is under manual driving to control the vehicle when vehicle driving becomes unstable, anxiety about an accident of the vehicle which is under manual driving may be reduced and safety of vehicle occupants may be improved.

Second, by switching the vehicle, which is under manual driving, to autonomous driving or performing driving correction on the vehicle based on the driving state of the vehicle, driving safety of the vehicle may be guaranteed.

Third, by verifying the driving state of the vehicle in an environment similar to the real world via display of a virtual object when a verification section is retrieved, or by verifying the driving state of the vehicle via comparison with driving information of another vehicle when no verification section is retrieved, the driving state may be verified with high accuracy.

Effects of the present disclosure are not limited to the effects mentioned above, and other unmentioned effects may be clearly understood by those skilled in the art from a description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device according to an embodiment.

FIG. 2 illustrates an AI server according to an embodiment.

FIG. 3 illustrates an AI system according to an embodiment.

FIG. 4 is a view illustrating monitoring of the driving state of a vehicle according to an embodiment of the present disclosure.

FIG. 5 is a view illustrating monitoring of the driving state of a vehicle and provision of related information in the case of speed verification according to an embodiment.

FIG. 6 is a view illustrating monitoring of the driving state of a vehicle and provision of related information in the case of steering verification according to an embodiment.

FIG. 7 is a view illustrating a procedure of monitoring, by a vehicle, the driving state of the vehicle according to an embodiment of the present disclosure.

FIG. 8 is a view illustrating a procedure of controlling driving of a vehicle according to an embodiment of the present disclosure.

FIG. 9 is a view illustrating a procedure of monitoring, by a server, the driving state of a vehicle according to an embodiment of the present disclosure.

FIG. 10 is a view illustrating a vehicle and a server, which monitor the driving state of the vehicle, according to an embodiment of the present disclosure.

FIG. 11 is a view illustrating an operation between a vehicle and a network according to an embodiment of the present disclosure.

FIG. 12 is a view illustrating an example of a vehicle-to-vehicle operation using wireless communication according to an embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Embodiments of the disclosure will be described hereinbelow with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

Exemplary embodiments of the present invention are described in detail with reference to the accompanying drawings.

Detailed descriptions of technical specifications well-known in the art and unrelated directly to the present invention may be omitted to avoid obscuring the subject matter of the present invention. This aims to omit unnecessary description so as to make clear the subject matter of the present invention.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

In addition, in this disclosure, extended reality collectively refers to virtual reality (VR), augmented reality (AR), and mixed reality (MR). VR technology provides real world objects or backgrounds only in CG images, AR technology provides virtually produced CG images on real objects images, and MR technology is a computer graphic technology that mixes and combines virtual objects in the real world and provides them.

MR technology is similar to AR technology in that it shows both real and virtual objects. However, there is a difference in that the virtual object is used as a complementary form to the real object in AR technology while the virtual object and the real object are used in the same nature in the MR technology.

XR technology can be applied to a HMD (Head-Mount Display), a HUD (Head-Up Display), a mobile phone, a tablet PC, a laptop, a desktop, a TV, a digital signage, etc., and a device to which XR technology is applied may be referred to as an XR device.

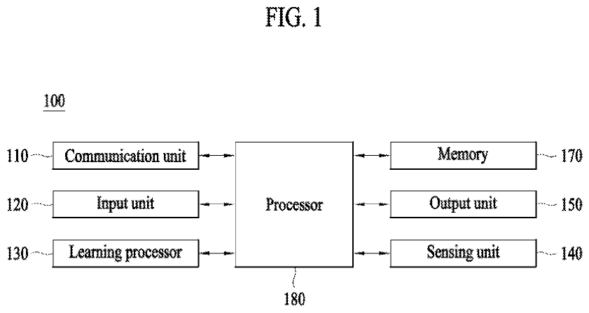

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

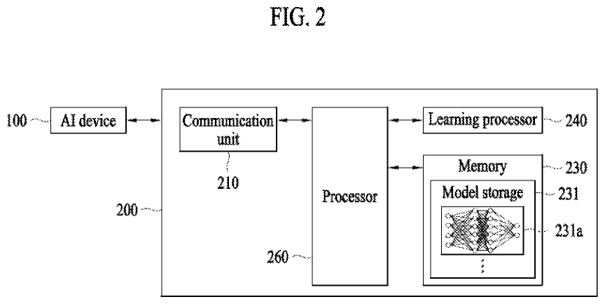

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

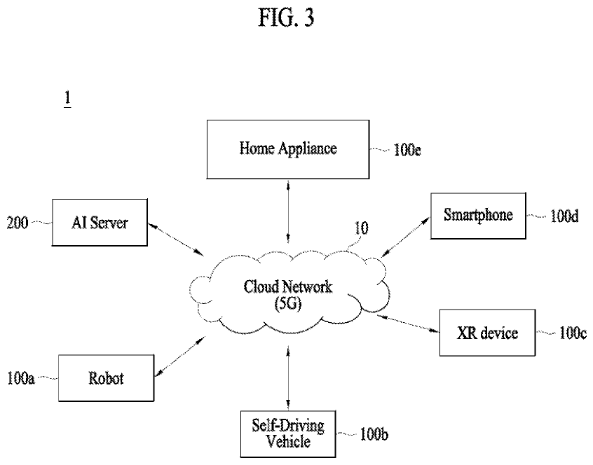

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

In addition, in the present disclosure, XR device 100c is applied with AI technology and implemented as a head-mount display (HMD), a head-up display (HUD) provided in a vehicle, a television, a mobile phone, a smartphone, a computer, a wearable device, and a home appliance. a digital signage, a vehicle, a fixed robot or a mobile robot.

XR device 100c may analyze three-dimensional point cloud data or image data obtained through various sensors or from an external device to generate location data and attribute data for three-dimensional points, thereby acquiring information on the surrounding space or reality object, rendering an XR object to output, and outputting it. For example, XR device 100c may output an XR object including additional information on the recognized object in correspondence with the recognized object.

XR device 100c may perform the above-described operations using a learning model composed of at least one artificial neural network. For example, XR device 100c may recognize a reality object in three-dimensional point cloud data or image data using the learning model, and may provide information corresponding to the recognized reality object. Here, the learning model may be learned directly at XR device 100c or learned from an external device such as AI server 200.

At this time, XR device 100c may perform an operation by generating a result using a learning model by itself, but may transmit sensor information to an external device such as AI server 200 and receive the result generated accordingly to perform an operation.

Autonomous vehicle 100b may be realized into, for example, a mobile robot, a vehicle, or an unmanned aerial vehicle, through application of AI technologies and XR technologies.

Autonomous vehicle 100b, to which XR technologies are applied, may refer to, for example, an autonomous vehicle having an XR image providing device or an autonomous vehicle as a control or interaction target in an XR image. In particular, autonomous vehicle 100b as a control or interaction target in an XR image may be distinguished from XR device 100c and may be connected to and operated with XR device 100c.

Autonomous vehicle 100b having an XR image providing device may acquire sensor information from sensors including a camera and may output an XR image generated based on the acquired sensor information. For example, autonomous vehicle 100b may include a head up display (HUD) to output an XR image, thereby providing an occupant with an XR object corresponding to a real object or an object on a screen.

The XR object may be output on the HUD such that at least a portion of the XR object may overlap a real object to which the occupant's gaze is directed. On the other hand, when the XR object is output on a display provided inside autonomous vehicle 100b, at least a portion of the XR object may overlap an object on a screen. For example, autonomous vehicle 100b may output XR objects corresponding to, for example, a road, another vehicle, a traffic light, a traffic sign, a motorcycle, a pedestrian, and a building.

When autonomous vehicle 100b as a control or interaction target in an XR image acquires sensor information from sensors including a camera, autonomous vehicle 100b or XR device 100c may generate an XR image based on the sensor information, and XR device 100c may output the generated XR image. Then, autonomous vehicle 100b may operate based on user interaction or in response to a control signal input through an external device such as XR device 100c.

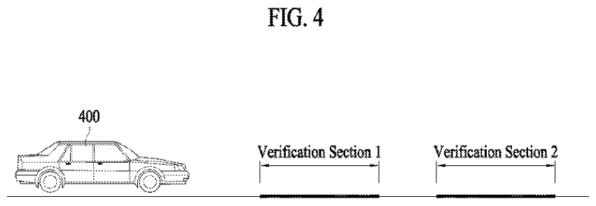

FIG. 4 is a view illustrating monitoring of the driving state of a vehicle according to an embodiment of the present disclosure.

A vehicle 400 may perform automatic driving or manual driving. In this specification, automatic driving may include autonomous driving. Vehicle 400 which is under automatic driving may be switched to manual driving in response to a user request. However, when there is a risk factor with relation to driving by a user who drives the vehicle, the vehicle may be switched from manual driving to automatic driving or may be subjected to driving correction, or the driving state of the vehicle which is under manual driving may be continuously monitored. For example, continuously monitoring the driving state of the vehicle which is under manual driving may include changing the cycle and sensitivity of collection of information to be monitored. For example, when there is a risk factor with relation to driving, a computation device may collect information more frequently or with higher sensitivity.

When vehicle 400 is switched from automatic driving to manual driving, driving information of vehicle 400 which is under manual driving may be collected in order to verify the driving state of vehicle 400. The driving information to be collected may include information related to driving of vehicle 400, and may include, for example, at least one of an expected driving route of vehicle 400, the volume of traffic on the expected driving route, a vehicle location, a vehicle driving speed, a vehicle position in a lane, the number of times a vehicle speed changes by a predetermined value or more for a predetermined time period (e.g., sudden stop and rapid acceleration), a steering angle at the time of a lane change, a distance between vehicles, and a driving image.

Vehicle 400 may determine, based on the collected driving information, whether at least one condition is satisfied in a predetermined section. The at least one condition may be whether there is a risk factor with relation to the driving state of vehicle 400. Specifically, vehicle 400 may determine whether there is a verification factor as a risk factor for vehicle 400 which is under manual driving. The verification factor may include information indicating a risky driving state of vehicle 400 which is under manual driving, and may include, for example, an increase or decrease in vehicle speed (e.g., rapid acceleration or rapid deceleration) by a predetermined value or more for a predetermined time period in a predetermined section and the number of times a vehicle speed increases or decreases. The verification factor may further include whether an average driving speed of vehicle 400 is higher or lower than an average driving speed of another vehicle for a predetermined time period in a predetermined section. The verification factor may further include whether the steering angle of the vehicle changes by more than a predetermined criterion at the time of a lane change in a predetermined section. The predetermined criterion may be determined based on at least one of a statistical value of the steering angle of the vehicle required at the time of a lane change according to traffic regulations and mechanical vehicle performance. The verification factor may further include at least one of a relative location of vehicle 400 in a lane, a change in driving speed depending on display of a real object, and a change in steering angle depending on display of a real object. Whether the at least one condition is satisfied may be determined based on whether the verification factor of vehicle 400 is identified. When the verification factor is identified from driving information, this may refer to the state in which the at least one condition is satisfied.

Moreover, vehicle 400 may determine whether the number of times at least one verification factor has occurred in a predetermined section is a preset value or more. Specifically, vehicle 400 may perform a driving state verification procedure when the number of times the verification factor has occurred in a predetermined section is a preset value or more, but may not perform the driving state verification procedure when the number of times the verification factor has occurred is less than the preset value. For example, assuming that the preset value is 2, vehicle 400 may perform the driving state verification procedure when the verification factor has occurred two or more times in a verification section 1, but may not perform the driving state verification procedure when the verification factor has occurred once in the verification section 1 and also has occurred once in a verification section 2. The verification section 1 and the verification section 2 may be included in an expected driving route of vehicle 400. In an embodiment, a verification section in which verification is performed may be determined based on statistical information acquired with relation to a driving route. More specifically, the statistical information may include driving information of other vehicles which travel on the driving route. Accordingly, an arbitrary section suitable for verification may be set to a verification section.

In an embodiment, the computation device may determine a next verification section based on a verification result in a specific verification section. For example, when it is determined, based on a verification result, that additional verification is required, the computation device may extend the specific verification section or change the next verification section to control next verification so as to be performed at an earlier time.

Vehicle 400 may identify a verification type corresponding to at least one condition. That is, vehicle 400 may identify a verification type corresponding to the verification factor identified from driving information. The verification type may include at least one of speed verification and steering verification. The speed verification may include verification related to the speed of vehicle 400, and the steering verification may include verification related to the steering of vehicle 400.

In an embodiment, when a verification factor, related to an increase or decrease in the speed of vehicle 400 by a predetermined value or more for a predetermined time period in a predetermined section, is identified from driving information of vehicle 400, vehicle 400 may identify speed verification as a verification type. In this case, the predetermined section, the predetermined time period, or the predetermined value may be set in advance with reference to a prescribed allowable range for each road. Here, the grade of speed verification may be subdivided based on the amount of change in speed. For example, the grade of speed verification of vehicle 400 may be determined by comparing the amount of change in the speed of vehicle 400 with a preset amount of change in speed. In addition, based on driving information of vehicle 400, when an average driving speed of vehicle 400 is higher (e.g., over the speed limit) or lower for a predetermined time period in a predetermined section compared to an average driving speed of other vehicles, vehicle 400 may identify speed verification as a verification type. The average driving speed of vehicle 400 may be an average speed in a predetermined section, and the average driving speed of other vehicles may be an average speed for the other vehicles which travel in the same section as vehicle 400. The same section as vehicle 400 may include a section in which the other vehicles travel at a distance close to vehicle 400. In addition, based on driving information of vehicle 400, when a change in the speed of vehicle 400 is greater than a preset criterion in a predetermined section after display of a real object, vehicle 400 may determine that response of a user who drives vehicle 400 is slow, and may identify speed verification as a verification type.

In an embodiment, when vehicle 400 changes a lane at a specific steering angle or more, vehicle 400 may identify steering verification as a verification type. Here, an average steering angle may be determined in consideration of at least one of the width of the lane and the speed of vehicle 400. In addition, when a distance between a left wheel of vehicle 400 and a left lane mark is a preset value or less for a predetermined time period or when a distance between a right wheel of vehicle 400 and a right lane mark is a preset value or less for predetermined time period, vehicle 400 may identify steering verification as a verification type. Specifically, steering verification may not be required when a time period during which the distance between the left wheel of vehicle 400 and the left lane mark is the preset value or less is less than the predetermined time period. The preset value may be determined in consideration of the width of vehicle 400 and the width of the lane. In addition, based on driving information of vehicle 400, when a change in the steering angle of vehicle 400 after display of a real object exceeds a preset criterion, vehicle 400 may identify steering verification as a verification type.

Vehicle 400 may perform speed verification or steering verification based on the identified verification type, or may verify the driving state with respect to each verification. Specifically, vehicle 400 may verify the driving state with respect to speed verification when only speed verification is identified, may verify the driving state with respect to steering verification when only steering verification is identified, or may verify the driving state with respect to each verification when both speed verification and steering verification are identified.

Vehicle 400, which has identified the verification type, may transmit information on the driving state of vehicle 400 to a server. The server may include a separate computation device provided inside or outside vehicle 400. The information on the driving state of vehicle 400 may include a location of vehicle 400, collected verification factors, verification types, and driver information.

When there is a verification section in which there is no change in driving of vehicle 400, the server may determine a first verification model corresponding to a verification type. The verification section in which there is no change in driving of vehicle 400 may be a section of an expected driving route of vehicle 400, such as a straight driving section, a section between traffic lights in which the vehicle may travel without a lane change, or a section in which the volume of traffic in a driving lane and an adjacent lane is less than a preset value (e.g., less than 30% of a typical volume of traffic). When one or more verification sections (e.g., a verification section 1, a verification section 2, a verification section 3, . . . ) are included in the expected driving route of vehicle 400, the driving state of vehicle 400 may be verified in a verification section close to the current location of vehicle 400 among the one or more verification sections. Such a verification section in which there is no change in driving may be a section having a low probability of an accident when the driving state of the vehicle is verified using the verification model.

When the verification section is determined, the server may determine the first verification model corresponding to the verification type. The first verification model may include at least one of a virtual object, a display position of the virtual object, and predicted control information of vehicle 400 depending on display of the virtual object, in order to perform speed verification or steering verification of vehicle 400 in the determined verification section.

The virtual object may be displayed on a display of vehicle 400 for verification of the driving state of vehicle 400. Specifically, in the case of speed verification, the virtual object may be an object capable of causing a change in the speed of vehicle 400 and may include, for example, at least one of a virtual traffic light, a virtual sign, a virtual crosswalk, and a virtual speed bump. In the case of steering verification, the virtual object may be an object capable of causing a change in the steering of vehicle 400 and may include, for example, at least one of a virtual vehicle present in a driving lane or an adjacent lane, a virtual sinkhole, and a virtual construction sign.

The display position of the virtual object may be set in the verification section. Specifically, in the case of speed verification, when displaying the virtual object in the verification section, the display position of the virtual object may be set to secure a predetermined distance depending on a change in the speed of vehicle 400. For example, when the current speed of vehicle 400 is 60 km/h and a virtual red traffic light is displayed, the display position of the virtual red traffic light may be set to secure a distance required for vehicle 400 to stop at the speed of 60 km/h. Alternatively, the display position may be set to secure a safe distance between vehicle 400 and another vehicle based on a change in the speed of vehicle 400. In the case of steering verification, when displaying the virtual object in the verification section, the display position of the virtual object may be set to secure a predetermined distance between vehicle 400 and another vehicle. For example, when vehicle 400 with a speed of 60 km/h moves to an adjacent lane due to display of a virtual construction sign, the display position of the virtual construction sign may be set to secure a predetermined distance between vehicle 400 and another vehicle in the adjacent lane.

A method of representing a virtual object may include a display method using a display of vehicle 400. The display of vehicle 400 may be a device capable of displaying image information on at least one of a front windshield, a sideview mirror, a rearview mirror, and a navigation system. Alternatively, a virtual object may be represented using sound corresponding thereto. The sound may be output through an acoustic device of vehicle 400 and may include, for example, voice information indicating appearance of the virtual object.

The predicted control information of vehicle 400 may include control information of vehicle 400 predicted by display of the virtual object. Specifically, when performing speed verification, the predicted control information may include a predicted change in driving of vehicle 400, which travels at a constant speed, due to display of the virtual object. When performing steering verification, the predicted control information may include a safe distance between vehicle 400 and another vehicle located in an adjacent lane when vehicle 400 moves to the adjacent lane due to display of the virtual object. For example, when it is notified to vehicle 400 which travels at a speed of 80 km/h that the speed limit is 70 km/h at 10 m in front of vehicle 400, the predicated control information may include a change in the speed of vehicle 400 while vehicle 400 moves 10 m. In addition, when it is notified to vehicle 400 which travels at a speed of 80 km/h that there is a virtual construction sign at 20 m in front of vehicle 400 in a driving lane, the predicted control information may include a safe distance between vehicle 400 and another vehicle located in an adjacent lane when vehicle 400 moves to the adjacent lane within a range of 20 m.

Information on the first verification model may be transmitted from the server to vehicle 400, and vehicle 400 may verify the driving state thereof using the received information on the first verification model. Vehicle 400 may transmit information indicating that vehicle 400 is in a verification state to other vehicles in the verification section using wireless communication (e.g., V2V communication or V2X communication). For example, the information may include at least one of a location of vehicle 400, information on vehicle 400, verification types, and verification models.

Vehicle 400 may verify the driving state thereof in the verification section based on the predicted control information. For example, in the case of speed verification, the degree of speed reduction of vehicle 400 depending on display of the virtual object at 10 m in front of vehicle 400 may be compared with the degree of speed reduction included in the predicted control information. In the case of steering verification, when vehicle 400 moves to an adjacent lane due to display of a virtual sinkhole and a distance between vehicle 400 and another vehicle located in the adjacent lane is 1 m, the distance of 1 m may be compared with an average distance of 3 m included in the predicated control information, and an error of the difference between vehicles may be 2 m.

According to one embodiment, vehicle driving may be controlled based on a comparison result between the predicted control information and information on a change in the driving state of vehicle 400. Specifically, when the predicted control information and information on a change in the driving state of vehicle 400 satisfy a preset first condition, vehicle 400 which is under manual driving may be switched to automatic driving. The preset first condition may be a case in which a difference between the predicted control information and information on a change in the driving state of vehicle 400 is equal to or greater than a preset first level. The preset first level may be determined by a statistical average value. As such, for example, when a difference between the predicted control information and information on a change in the driving state of vehicle 400 is equal to or greater than 60% which is the preset first level, vehicle 400 which is under manual driving may be switched to automatic driving.

After switched to automatic driving, the driving state of vehicle 400 may be re-verified using a second verification model in response to a request for switching to manual driving to vehicle 400. A verification section of the second verification model may also be determined in the same manner as the verification section of the first verification model. The second verification model may be a model in which the display position of the virtual object or the predicted control information of vehicle 400 is adjusted, compared to the first verification model. For example, when a virtual red traffic light is displayed at 20 m in front of vehicle 400 in the first verification model, the virtual red traffic light may be displayed at 10 m in front of vehicle 400 in the second verification model to demand a faster driver response than in the first verification model. That is, the second verification model may more strictly verify the driving state of vehicle 400 than the first verification model.

When the driving state of vehicle 400 satisfies the predicted control information based on the second verification model, vehicle 400 may be switched from automatic driving to manual driving. When the driving state of vehicle 400 does not satisfy the predicted control information based on the second verification model, vehicle 400 may not be switched from automatic driving to manual driving.

Once vehicle 400 has been switched to automatic driving, vehicle 400 may not permit a request for switching to manual driving while moving a predetermined distance. In this case, vehicle 400 may notify that a switching request is not possible, and may retrieve and notify a switching request permission section. The switching request permission section may be a section in which the user has restored quiet, which is determined in consideration of user's physical conditions (e.g., user's blood pressure, user's pulse, and a user's electrocardiogram (ECG) signal). For example, after switched to automatic driving, vehicle 400 may monitor a user's ECG signal and may notify the user of that a switching request is possible when the ECG signal reaches a stable state.

According to another embodiment, vehicle driving may be controlled based on a comparison result between the predicted control information and information on a change in the driving state of vehicle 400. Specifically, when the predicted control information and information on a change in the driving state of vehicle 400 satisfy a preset second condition, vehicle 400 which is under manual driving may be subjected to driving correction. The preset second condition may be a case in which a difference between the predicted control information and information on a change in the driving state of vehicle 400 is less than the preset first level and is equal to or greater than a preset second level. The preset first level and the preset second level may be determined by statistical average values. As such, for example, when a difference between the predicted control information and information on a change in the driving state of vehicle 400 is within an error range from 20% to less than 60% (i.e. less than the first level and equal to or greater than the second level) to satisfy the preset second condition, vehicle 400 which is under manual driving may be subjected to driving correction.

The driving correction may include guiding the verification factor for vehicle 400 so as to calibrate driving. In other words, driving correction may depend on the verification factor. For example, when the speed limit is 80 km/h in a specific section and a user tends to speed, the speed limit of 70 km/h may be guided to calibrate user driving. The speed limit to be guided may be determined based on the degree by which the user is speeding. For example, when the user tends to exceed the speed limit by more than 20 km/h on average, the speed limit to be guided may be determined in consideration of the degree of speeding. In another example, when a distance between vehicles, required for a lane change, is 1 m, a distance required for a lane change may be guided to 2 m to calibrate user driving.

After provision of information on driving correction for vehicle 400 which is under manual driving, vehicle 400 may monitor whether the verification factor is reconfirmed in a predetermined section. When the verification factor is reconfirmed in the predetermined section, vehicle 400 which is under manual driving may be switched to automatic driving. On the other hand, when the verification factor is not reconfirmed in the predetermined section, the driving state of vehicle 400 may be re-verified using the first verification model. For example, when a distance between vehicles is changed to 2 m, whether the verification factor is reconfirmed may be monitored while vehicle 400 moves 1 km, and when the verification factor is reconfirmed, vehicle 400 may be switched from manual driving to automatic driving. In another example, when a distance between vehicles is changed to 2 m, whether the verification factor is reconfirmed may be monitored while vehicle 400 moves 1 km, and when the verification factor is not reconfirmed, the driving state of vehicle 400 may be re-verified using the verification model.

According to a further embodiment, vehicle driving may be controlled based on a comparison result between the predicted control information and information on a change in the driving state of vehicle 400. Specifically, when a difference between the predicted control information and information on a change in the driving state of vehicle 400 is less than the preset second level, the driving state of vehicle 400 may be continuously monitored without driving correction or driving switching of vehicle 400 which is under manual driving.

When the verification section in which the driving state of vehicle 400 is verified is not retrieved, the driving state of vehicle 400 may be verified via comparison between driving information of vehicle 400 and driving information of another vehicle in a predetermined section. Specifically, when no verification section is retrieved, vehicle 400 may transmit driving information of vehicle 400 to the server. The driving information to be transmitted may include an expected driving route, the volume of traffic on the expected driving route, a vehicle location, a vehicle driving speed, a vehicle position in a lane, the number of times a vehicle speed changes by a predetermined value or more for a predetermined time period (e.g., sudden stop and rapid acceleration), a steering angle at the time of a lane change, a distance between vehicles, and a driving image. The driving state of vehicle 400 may be verified via comparison between driving information of vehicle 400 in a predetermined section and average driving information of other vehicles in the predetermined section. As in the case in which the verification section is retrieved, driving switching (e.g., switching from manual driving to automatic driving), driving correction, and continuous driving state monitoring for vehicle 400 may be performed based on a verification result of the driving state even when no verification section is retrieved. That is, the driving state of vehicle 400 may be verified based on the transmitted driving information.

According to the embodiments, information on a user who has caused switching from manual driving to automatic driving or driving correction at least one time may be recorded and managed. Moreover, manual driving of a user who has caused driving switching or driving correction a preset number of times may be restricted.

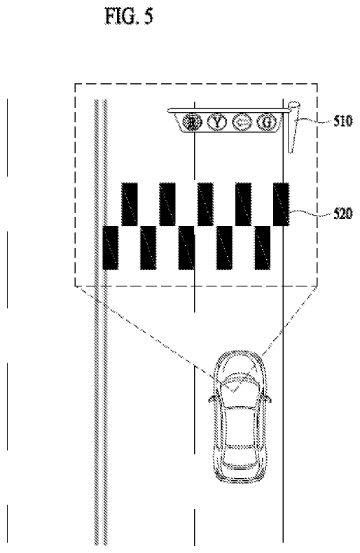

FIG. 5 is a view illustrating monitoring of the driving state of a vehicle and provision of related information in the case of speed verification according to an embodiment. FIG. 5 illustrates that a virtual crosswalk 520 and a virtual red traffic light 510 are displayed on a front display of a vehicle that is under manual driving so that speed verification for the vehicle is performed.

A vehicle may be driven manually by a driver. Driving information of the vehicle which is under manual driving may be collected. The vehicle driving information to be collected may include an expected driving route, the volume of traffic on the expected driving route, a vehicle location, a vehicle driving speed, a vehicle position in a lane, the number of times a vehicle speed changes by a predetermined value or more for a predetermined time period (e.g., sudden stop and rapid acceleration), a steering angle at the time of a lane change, a distance between vehicles, and a driving image.

According to an embodiment, when at least one verification factor is identified in a predetermined section from the collected driving information, a verification type corresponding to the verification factor may be identified. Specifically, when a vehicle speeding condition is satisfied in the predetermined section, the verification type corresponding to speeding as a risk factor may be speed verification.

The vehicle may transmit at least one of the collected driving information, the verification factor, and the verification type to a server, and the server may extract at least one verification section in which there is no change in driving from among several sections extracted from an expected driving route of the vehicle. The server including a computation device may be mounted inside or outside the vehicle. In one example, the verification section may be a section of an expected driving route such as a straight driving section, a section between traffic lights in which the vehicle may travel without a lane change, or a section in which the volume of traffic in a driving lane and an adjacent lane is less than a preset value (e.g., less than 30% of a typical volume of traffic). When one or more verification sections (e.g., a verification section 1, a verification section 2, a verification section 3, . . . ) are included in the expected driving route of the vehicle, the driving state of the vehicle may be verified in a verification section close to the current location of the vehicle among the one or more verification sections.

The server may determine a first verification model for performing speed verification. The first verification model may include at least one of a virtual object corresponding to speed verification, a display position of the virtual object, and predicted control information of the vehicle depending on display of the virtual object. The virtual object may be an object capable of causing a change in the speed of the vehicle. The display position of the virtual object may be set in the verification section to allow the vehicle to secure a predetermined distance. Specifically, the display position may be set to secure a vehicle driving distance depending on acceleration or deceleration, or may be set to secure a predetermined distance between vehicles based on a change in speed. The predicted control information of the vehicle may include a change in the speed of the vehicle or a change in the driving distance of the vehicle depending on display of the virtual object in the verification section.

For example, the driver may collect driving information from a vehicle which is under manual driving. When it is determined, based on the collected driving information, that the vehicle is speeding, the vehicle may transmit the collected driving information, a verification factor (e.g., speeding), and a verification type (e.g., speed verification) to the server. The server, which has received such data, may extract a verification section in which there is no change in driving from an expected driving route of the vehicle. The server may determine a first verification model for performing speed verification, and may transmit information on the first verification model to the vehicle. A virtual object may be determined based on the verification section of the vehicle. For example, a virtual red traffic light suitable for performing speed verification in the verification section in which there is no change in driving may be determined as the virtual object. The virtual red traffic light may be generated at a specific position in the verification section in consideration of at least one of a vehicle driving speed, the volume of traffic, and a relationship between the vehicle and another vehicle, and the generated virtual red traffic light may be displayed on a display. The driver who views the virtual red traffic light displayed on the display may stop the vehicle.

Information on a change in the driving state of the vehicle depending on display of the virtual object may include a change in the speed of the vehicle, the amount of change in the speed of the vehicle, a driving distance depending on a change in the speed of the vehicle, and a distance between the vehicle and another vehicle. The driving state of the vehicle may be monitored via comparison between predicted control information and the information on a change in the driving state of the vehicle. For example, predicted control information may be compared with a change in the speed of the vehicle, which travels at 60 km/h, and a distance required for the vehicle to stop depending on display of the virtual red traffic light. Such a change in the speed of the vehicle or a driving distance depending on a change in speed may be used to measure a response of the driver to display of the virtual red traffic light.

Then, when a difference between information on a change in the driving state of the vehicle due to display of the virtual object and predicted control information is equal to or greater than a preset first level (when a preset first condition is satisfied), the vehicle may be switched from manual driving to automatic driving. After switched to automatic driving, when a request for switching to manual driving to the vehicle is confirmed, the driving state of the vehicle may be re-verified using a second verification model corresponding to speed verification. The second verification model may be a model in which the display position of the virtual object or the predicted control information is adjusted, compared to the first verification model. For example, when the first verification model is determined such that the virtual red traffic light is displayed at 20 m in front of the vehicle and a driving distance required for the vehicle to stop is 19 m, the second verification model may be determined such that the virtual red traffic light is displayed at 10 m in front of the vehicle and a driving distance required for the vehicle to stop is 9 m. Thereby, a response of the driver to sudden display of the virtual object may be measured more strictly.

When the difference between information on a change in the driving state of the vehicle due to display of the virtual object and predicted control information is less than the first level and is equal to or greater than a preset second level (when a preset second condition is satisfied), driving correction for the vehicle may be performed. The driving correction may be performed to reduce a probability of the verification factor. For example, when the verification factor is speeding, driving correction may be guided to limit the speed of the vehicle. When the verification factor is reconfirmed in a predetermined section after the vehicle is controlled to undergo driving correction, the vehicle which is under manual driving may be switched to automatic driving.

When the difference between information on a change in the driving state of the vehicle due to display of the virtual object and predicted control information is less than the preset second level, the driving state of the vehicle may be continuously monitored without driving switching or driving correction. The description related to verification of the driving state with reference to FIG. 4 may also be applied to FIG. 5.

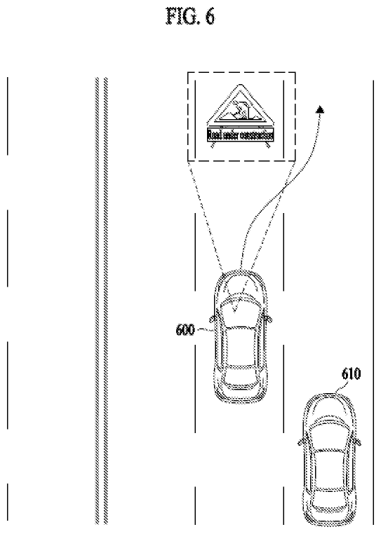

FIG. 6 is a view illustrating monitoring of the driving state of a vehicle and provision of related information in the case of steering verification according to an embodiment. FIG. 6 illustrates that a road construction sign is output on a front display of a vehicle so that steering verification for the vehicle is performed.

A vehicle may be driven manually by a driver. Driving information of the vehicle which is under manual driving may be collected. The vehicle driving information to be collected may include an expected driving route, the volume of traffic on the expected driving route, a vehicle location, a vehicle driving speed, a vehicle position in a lane, the number of times a vehicle speed changes by a predetermined value or more for a predetermined time period (e.g., sudden stop and rapid acceleration), a steering angle at the time of a lane change, a distance between vehicles, and a driving image.

According to an embodiment, when at least one verification factor is identified in a predetermined section from the collected driving information, a verification type corresponding to the verification factor may be identified. Specifically, when a distance between the vehicle and another vehicle in an adjacent lane is 1 m by movement of the vehicle to the adjacent lane in a predetermined section, the verification type may be steering verification. A safe distance between adjacent vehicles at the time of a lane change may be set in advance.

The vehicle may transmit at least one of the collected driving information, the verification factor, and the verification type to a server, and the server may extract at least one verification section in which there is no change in driving from among several sections extracted from an expected driving route of the vehicle. The server including a computation device may be mounted inside or outside the vehicle. In one example, the verification section may be a section of an expected driving route, such as a straight driving section, a section between traffic lights in which the vehicle may travel without a lane change, or a section in which the volume of traffic in a driving lane and an adjacent lane is less than a preset value (e.g., less than 30% of a typical volume of traffic). When one or more verification sections (e.g., a verification section 1, a verification section 2, a verification section 3, . . . ) are included in the expected driving route of the vehicle, the driving state of the vehicle may be verified in a verification section close to the current location of the vehicle among the one or more verification sections.

The server may determine a first verification model for performing steering verification. The first verification model may include at least one of a virtual object corresponding to steering verification, a display position of the virtual object, and predicted control information of the vehicle depending on display of the virtual object. The virtual object may be an object capable of causing a change in the steering of the vehicle. The display position of the virtual object may be set in the verification section to allow the vehicle to secure a predetermined distance. Specifically, the display position may be set to secure a predetermined distance between the vehicle and another vehicle in an adjacent lane at the time of a lane change. The predicted control information of the vehicle may include a predicted distance between the vehicle and another vehicle depending on display of the virtual object in the verification section.

For example, the driver may collect driving information from a vehicle which is under manual driving. When it is determined, based on the collected driving information, that a vehicle 600 changes a lane so that a distance from another vehicle 610 traveling in an adjacent lane is 1 m, the vehicle may transmit the collected driving information, a verification factor, and a verification type (e.g., steering verification) to the server. The server, which has received such data, may extract a verification section in which there is no change in driving from an expected driving route of the vehicle. The server may determine a first verification model for performing steering verification, and may transmit information on the first verification model to vehicle 600. A virtual object may be determined based on the verification section of vehicle 600. For example, a virtual construction sign suitable for performing steering verification in the verification section in which there is no change in driving may be determined as the virtual object. The virtual construction sign may be generated at a specific position in the verification section in consideration of at least one of a driving speed of vehicle 600, the volume of traffic, and a relationship between vehicle 600 and vehicle 610, and the generated virtual construction sign may be displayed on a display. The driver who views the virtual construction sign displayed on the display may change a lane.

The predicated control information may include a predicted distance between vehicle 600 and vehicle 610 depending on display of the virtual object. The predicted distance may be set in advance as a safe distance between vehicles required for a lane change. For example, the safe distance between vehicles required for a lane change may be set to 2 m in advance.

Then, when a difference between the predicted distance and the distance between vehicle 600 and vehicle 610 is equal to or greater than a preset first level (when a preset first condition is satisfied), the vehicle may be switched from manual driving to automatic driving. The preset first level may be determined by a statistical average value. After switched to automatic driving, when a request for switching to manual driving to vehicle 600 is confirmed, the driving state of the vehicle may be re-verified using a second verification model corresponding to steering verification. The second verification model may be a model in which the display position of the virtual object or the predicted control information is adjusted, compared to the first verification model. For example, when the first verification model is determined such that the distance between vehicle 600 and vehicle 610 is 2 m at the time of a lane change depending on display of the virtual construction sign, the second verification model may be determined such that the distance between vehicle 600 and vehicle 610 is 3 m. Such an increase in the distance between vehicles may ensure a safer lane change. In another example, the virtual construction sign may be displayed at 20 m in front of the vehicle to measure a response of the driver in the first verification model, whereas the virtual construction sign may be displayed at 10 m in front of the vehicle to demand a faster response of the driver in the second verification model.

When the difference between the predicted distance and the distance between vehicle 600 and vehicle 610 is less than the first level and is equal to or greater than a preset second level (when a preset second condition is satisfied), driving correction for the vehicle may be performed. The preset second level may also be determined by a statistical average value. The driving correction may be performed to reduce a probability of the verification factor. For example, when the verification factor is a distance between vehicles at the time of a lane change, driving correction may be guided to secure a safe distance between vehicles. When the verification factor is reconfirmed in a predetermined section after the vehicle is controlled to undergo driving correction, the vehicle which is under manual driving may be switched to automatic driving.

When the difference between the predicted distance and the distance between vehicle 600 and vehicle 610 is less than the preset second level, the driving state of the vehicle may be continuously monitored without driving switching or driving correction. The description related to verification of the driving state with reference to FIG. 4 may also be applied to FIG. 6.

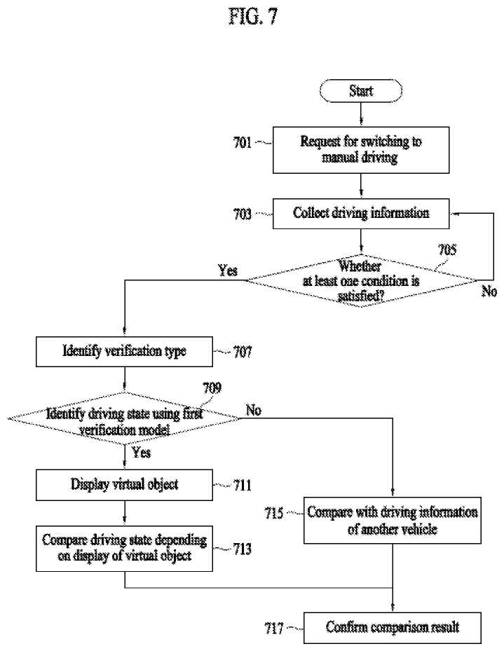

FIG. 7 is a view illustrating a procedure of monitoring, by a vehicle, the driving state of the vehicle according to an embodiment of the present disclosure.

A request for switching of a vehicle to manual driving may be made by a user (701). Driving information of the vehicle which is under manual driving may be collected (703). The driving information to be collected may include information related to driving of the vehicle. For example, information related to an expected driving route of the vehicle, the volume of traffic on the expected driving route, a vehicle location, a vehicle driving speed, a vehicle position in a lane, the number of times a vehicle speed changes by a predetermined value or more for a predetermined time period (e.g., sudden stop and rapid acceleration), a steering angle at the time of a lane change, a distance between vehicles, and a driving image may be collected as the driving information.

The vehicle may determine, based on the collected driving information, whether a verification factor has occurred (705). The verification factor may include information indicating a risky driving state of the vehicle which is under manual driving. For example, the verification factor may include an increase or decrease in vehicle speed (e.g., rapid acceleration or rapid deceleration) by a predetermined value or more for a predetermined time period in a predetermined section and the number of times a vehicle speed increases or decreases. The verification factor may further include whether an average driving speed of the vehicle is higher or lower than an average driving speed of other vehicles for a predetermined time period in a predetermined section. The verification factor may further include whether the steering angle of the vehicle changes by more than a predetermined criterion at the time of a lane change in a predetermined section. The predetermined criterion may include a statistical value of the steering angle of the vehicle required at the time of a lane change according to traffic regulations. The verification factor may further include at least one of a relative location of the vehicle in a lane, a change in driving speed depending on display of a real object, and a change in steering angle depending on display of a real object.

The vehicle may identify a verification type corresponding to the determined verification factor (707). The verification type may include speed verification and steering verification. The speed verification may include verification related to the speed of the vehicle, and the steering verification may include verification related to the steering of the vehicle. The vehicle may perform speed verification or steering verification based on the identified verification type, or may verify the driving state with respect to each verification. Specifically, the vehicle may verify the driving state with respect to speed verification when only speed verification is identified, may verify the driving state with respect to steering verification when only steering verification is identified, or may verify the driving state with respect to each verification when both verification and steering verification are identified.

After identifying the verification type, the vehicle may transmit information on the driving state of the vehicle to a server. The server may include a separate computation device provided inside or outside the vehicle. The information on the driving state of the vehicle may include a location of the vehicle, collected verification factors, verification types, and driver information.

When there is a verification section in which there is no change in driving of the vehicle, the server may determine a first verification model corresponding to the verification type. The verification section in which there is no change in driving of the vehicle may be a section of an expected driving route, such as a straight driving section, a section between traffic lights in which the vehicle may travel without a lane change, or a section in which the volume of traffic in a driving lane and an adjacent lane is less than a preset value (e.g., less than 30% of a typical volume of traffic). When one or more verification sections (e.g., a verification section 1, a verification section 2, a verification section 3, . . . ) are included in an expected driving route of the vehicle, the driving state of the vehicle may be verified in a verification section close to the current location of the vehicle among the one or more verification sections.

The server may determine the first verification model which may be applied to the verification section, and may transmit information on the first verification model to the vehicle. The vehicle may verify the driving state of the vehicle using the information on the first verification model (709). The first verification model may include at least one of a virtual object, a display position of the virtual object, and predicted control information of the vehicle depending on display of the virtual object, in order to perform speed verification or steering verification of the vehicle in the determined verification section.

The vehicle may display a virtual object based on the first verification model (711). The virtual object may be displayed on a device capable of displaying a screen, such as a front windshield, a sideview mirror, a rearview mirror, and a navigation system. Alternatively, a virtual object may be output through an acoustic device of the vehicle.

In the case of speed verification, the virtual object may be an object capable of causing a change in the speed of the vehicle and may include, for example, at least one of a virtual traffic light, a virtual sign, a virtual crosswalk, and a virtual speed bump. In the case of steering verification, the virtual object may be an object capable of causing a change in the steering of the vehicle and may include, for example, at least one of a virtual vehicle present in a driving lane or an adjacent lane, a virtual sinkhole, and a virtual construction sign.

The display position of the virtual object may be set in the verification section to allow the vehicle to secure a predetermined distance. Specifically, in the case of speed verification, the display position of the virtual object may be set in the verification section to secure a vehicle driving distance based on a change in the speed of the vehicle and thus, to secure a predetermined distance between the vehicle and another vehicle. In the case of steering verification, the display position of the virtual object may be set to secure a predetermined distance between the vehicle and another vehicle in an adjacent lane when the vehicle moves to the adjacent lane depending on display of the virtual object in the verification section.

The predicted control information depending on display of the virtual object may include control information of the vehicle predicted when the virtual object is displayed. Specifically, in the case of speed verification, the predicted control information may include a predicted change in driving of the vehicle, which travels at a constant speed, due to display of the virtual object. In the case of steering verification, the predicted control information may include a safe distance between the vehicle and another vehicle located in an adjacent lane when the vehicle moves to the adjacent lane due to display of the virtual object.

The vehicle may verify the driving state depending on display of the virtual object. The vehicle may compare the driving state of the vehicle with the predicted control information depending on display of the virtual object in the verification section (713).

When the verification section in which the driving state of the vehicle is verified is not retrieved, the server may not transmit information on the first verification model to the vehicle. In this case, the driving state of the vehicle may be verified via comparison between driving information of the vehicle and driving information of another vehicle in a predetermined section (715). Specifically, when no verification section is retrieved, the vehicle may transmit driving information of the vehicle to the server. The driving information to be transmitted may include an expected driving route, the volume of traffic on the expected driving route, a vehicle location, a vehicle driving speed, a vehicle position in a lane, the number of times a vehicle speed changes by a predetermined value or more for a predetermined time period (e.g., sudden stop and rapid acceleration), a steering angle at the time of a lane change, a distance between vehicles, and a driving image. The driving state of the vehicle may be verified via comparison between driving information of the vehicle in a predetermined section and average driving information of other vehicles in the predetermined section.

Both when the verification section is retrieved and when no verification section is retrieved, the vehicle may confirm a comparison result (717). When the verification section is retrieved, the predicted control information and information on a change in the driving state of the vehicle may be compared, and the driving state of the vehicle may be verified based on a comparison result. When no verification section is retrieved, driving information of the vehicle and driving information of another vehicle in a predetermined section may be compared, and the driving state of the vehicle may be verified based on a comparison result. The above description related to the vehicle and the server may also be applied to FIG. 7.

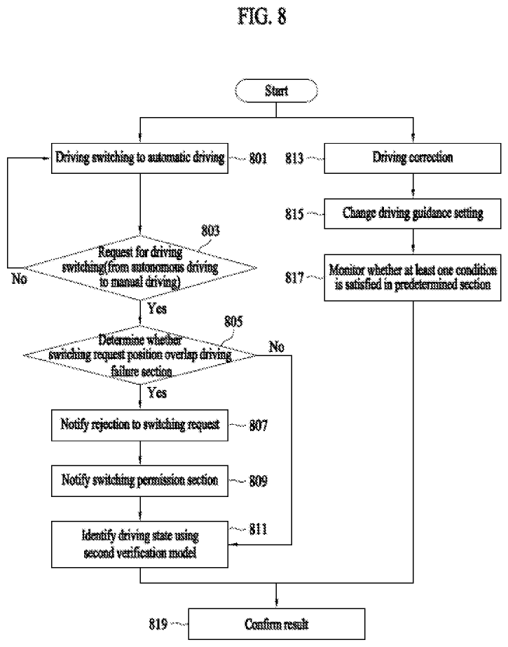

FIG. 8 is a view illustrating a procedure of controlling driving of a vehicle according to an embodiment of the present disclosure.

Both when the verification section is retrieved and when the verification section is not retrieved, the driving state of a vehicle may be verified. Based on the driving state of the vehicle, driving switching or driving correction for the vehicle may be performed, or the driving state of the vehicle may be continuously monitored.

When a difference between the driving state of the vehicle and predicted control information is equal to or greater than a preset first level (when a preset first condition is satisfied), the vehicle which is under manual driving may be switched to automatic driving (801). The preset first level may be determined by a statistical average value. For example, when a difference between information on a change in the driving state of the vehicle and predicted control information is equal to or greater than 60% which is the preset first level, the vehicle which is under manual driving may be switched to automatic driving under control. Alternatively, when no verification section is retrieved and a difference between driving information of the vehicle and average driving information of other vehicles in a predetermined section is equal to or greater than the preset first level, the vehicle which is under manual driving may be switched to automatic driving (801).

After switching to automatic driving, a switching request 803 for manual driving to the vehicle may be reconfirmed. When no switching request 803 for manual driving to the vehicle is confirmed, the vehicle may be under automatic driving.

In response to the switching request 803, the vehicle may determine whether a location in which the switching request is confirmed overlaps a driving failure section 805. The driving failure section may be a section in which the vehicle which is under manual driving has ever undergone switching to automatic driving (801). Since the driving failure section is determined as having a risk factor with relation to the driving state of the vehicle, the vehicle may remain in automatic driving in the driving failure section. When the switching request 803 for manual driving is again input to the vehicle in the driving failure section, the vehicle may provide a rejection notice 807 for the switching request. Thereafter, the vehicle may provide a notice 809 for a switching permission section in which switching from manual driving to automatic driving is possible. The switching permission section may not overlap the driving failure section. For example, the vehicle may provide a notice of “Switching to automatic driving has occurred due to unstable manual driving. You can request to switch again after the driving failure section, and the switching possible section is after 600 m”. When the vehicle enters the switching permission section, the driving state of the vehicle may be verified using a second verification model (811). The second verification model may be a model in which the display position of a virtual object or predicted control information of the vehicle is adjusted, compared to a first verification model. For example, when a virtual red traffic light is displayed at 30 m in front of the vehicle with a speed of 60 km/h in the first verification model, the virtual red traffic light may be displayed at 20 m in front of the vehicle in the second verification model. Thereby, the driving state of the vehicle which is under manual driving may be monitored more strictly by comparing the predicted control information with the amount of change in driving information until the vehicle stops based on the second verification model. The second verification model may be used to confirm a faster response of a user, who drives the vehicle, to the virtual object, compared to the first verification model.

When a difference between predicted distance and the driving state of the vehicle is less than the first level and is equal to or greater than a preset second level (when a preset second condition is satisfied), driving correction for the vehicle which is under manual driving may be guided (813). The preset first level and the preset second level may be determined by statistical average values. For example, when a difference between predicted control information and the driving state of the vehicle is within an error range from 20% to less than 60% (i.e. less than the first level and equal to or greater than the second level), the vehicle which is under manual driving may be subjected to driving correction. Alternatively, when no verification section is retrieved and a difference between driving information of the vehicle and average driving information of other vehicles in a predetermined section is less than the first level and is equal to or greater than the preset second level, the vehicle which is under manual driving may be subjected to driving correction (813).

The driving correction may include guiding a verification factor for the vehicle so as to be calibrated. Thereby, by driving correction 813, driving guidance settings may be changed (815). For example, when the speed limit is 80 km/h in a specific section and a user tends to speed, the speed limit of 70 km/h may be guided to calibrate user driving. The speed limit to be guided may be determined based on the degree by which the user is speeding. For example, when the user tends to exceed the speed limit by more than 20 km/h on average, the speed limit to be guided may be determined in consideration of the degree of speeding. In another example, when a distance between vehicles, required for a lane change, is 1 m, a distance required for a lane change may be guided to 2 m to calibrate user driving.

After provision of information on driving correction for the vehicle which is under manual driving, whether the verification factor is reconfirmed in a predetermined section may be monitored (817). When the verification factor is reconfirmed within the predetermined section, the vehicle which is under manual driving may be switched to automatic driving. On the other hand, when the verification factor is not reconfirmed in the predetermined section, the driving state of the vehicle may be re-verified based on the first verification model. For example, when a distance between vehicles is changed to 2 m, whether the verification factor is reconfirmed may be monitored while the vehicle moves 1 km, and when the verification factor is reconfirmed, the vehicle may be switched from manual driving to automatic driving. In another example, when a distance between vehicles is changed to 2 m, whether the verification factor is reconfirmed may be monitored while the vehicle moves 1 km, and when the verification factor is not reconfirmed, the driving state of the vehicle may be re-verified based on the verification model.

When the difference between predicted control information and the driving state of the vehicle is less than the preset second level, the driving state of the vehicle which is under manual driving may be continuously monitored without driving switching and driving correction.

The vehicle may confirm a result of driving switching 801 (819). As a result of verifying the driving state using the second verification model (811), the vehicle may remain under automatic driving or may be switched from automatic driving to manual driving. Alternatively, the vehicle may confirm a result of driving correction 813 (819). After monitoring whether the verification factor is reconfirmed within a predetermined section, the driving state of the vehicle may be continuously monitored without switching to automatic driving or driving correction.

According to the embodiments, information on a user who has caused switching from manual driving to automatic driving or driving correction at least one time may be recorded and managed. Moreover, manual driving of a user who has caused driving switching or driving correction a preset number of times may be restricted. The above description related to the vehicle and the server may also be applied to FIG. 8.

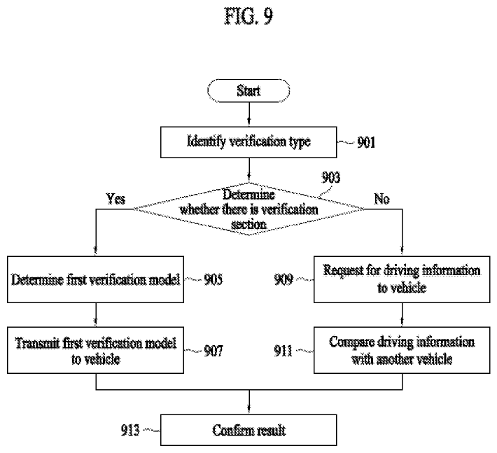

FIG. 9 is a view illustrating a procedure of monitoring, by a server, the driving state of a vehicle according to an embodiment of the present disclosure.

A server may confirm driving information received from a vehicle which is under manual driving. The received vehicle driving information may an expected driving route, the volume of traffic on the expected driving route, a vehicle location, a vehicle driving speed, a vehicle position in a lane, the number of times a vehicle speed changes by a predetermined value or more for a predetermined time period (e.g., sudden stop and rapid acceleration), a steering angle at the time of a lane change, a distance between vehicles, and a driving image. The vehicle may identify a verification factor and/or a verification type from the driving information, and may transmit the identified verification factor and/or verification type to the server. As such, the server may identify not only the driving information but also the verification factor and the verification type (901).

The server may determine the presence or absence of a verification section (903). The server may extract at least one verification section in which there is no change in driving from among several sections extracted from an expected driving route of the vehicle. For example, the verification section may be a section of an expected driving route, such as a straight driving section, a section between traffic lights in which the vehicle may travel without a lane change, or a section in which the volume of traffic in a driving lane and an adjacent lane is less than a preset value (e.g., less than 30% of a typical volume of traffic). When one or more verification sections (e.g., a verification section 1, a verification section 2, a verification section 3, . . . ) are included in an expected driving route of the vehicle, the driving state of the vehicle may be verified in a verification section close to the current location of the vehicle among the one or more verification sections.

When the verification section is retrieved, the server may determine a first verification model in consideration of at least one of the driving information, the verification factor, and the verification type (905). The first verification model may include at least one of a virtual object corresponding to speed verification, a display position of the virtual object, and predicted control information of the vehicle depending on display of the virtual object. The virtual object may be an object capable of causing a change in the speed of the vehicle. The display position of the virtual object may be set to secure a vehicle driving distance depending on acceleration or deceleration. The predicted control information of the vehicle may include a change in driving of the vehicle caused when the virtual object is displayed in the verification section.

The server may transmit information on the determined first verification model to the vehicle (907). The vehicle may verify the driving state of the vehicle in the verification section using the received first verification model. The driving state of the vehicle may be transmitted to the server, and the server may confirm a verification result for the driving state of the vehicle (913).

When no verification section is retrieved, the server may transmit a request for driving information to the vehicle (909). The vehicle which has received the request may transmit driving information of the vehicle to the server. The server may compare the driving information of the vehicle with average driving information of other vehicles in a predetermined section (911), and may confirm a result of the driving state of the vehicle (913).

Driving control of the vehicle may be determined based on the driving state of the vehicle. When it is determined that there is a risk factor with relation to the vehicle which is under manual driving, the vehicle may be switched to automatic driving or may be subjected to driving correction to reduce a probability of a verification factor, or the driving state of the vehicle may be continuously monitored. In the case of driving switching, the server may determine and transmit a second verification model to the vehicle when a predetermined condition is satisfied. In the case of driving correction, the server may transmit a change in driving guidance settings to the vehicle. The above description related to the vehicle and the server may also be applied to FIG. 9.

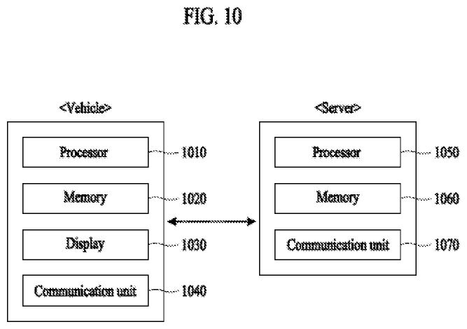

FIG. 10 is a view illustrating a vehicle and a server, which monitor the driving state of the vehicle, according to an embodiment of the present disclosure.

According to an embodiment of the present disclosure, the vehicle may include a processor 1010, a memory 1020, a display 1030, and a communication unit 1040. In addition, the server, which is a computation device provided inside or outside the vehicle, may include a processor 1050, a memory 1060, and a communication unit 1070.

The vehicle may acquire driving information, and processor 1010 may identify a verification factor and a verification type from the acquired driving information. Communication unit 1040 of the vehicle may transmit at least one of driving information, the verification factor, and the verification type to communication unit 1070 of the server. Processor 1050 may determine whether or not to extract a verification section using received data, and may generate a verification model used to verify the driving state of the vehicle when the verification section is extracted. Processor 1010 may verify the driving state of the vehicle using the verification model, and display 1030 may output a virtual object depending on the verification model. A more detailed description related to the vehicle and the server will be replaced with the above description.

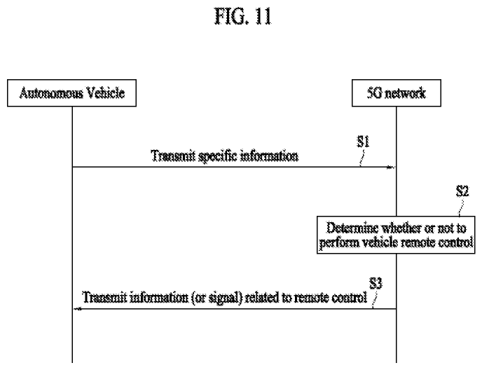

FIG. 11 is a view illustrating an operation between a vehicle and a network according to an embodiment of the present disclosure. Specifically, FIG. 11 illustrates an operation between an autonomous vehicle and a network using wireless communication. The wireless communication may be, for example, 5G communication, and the network may be, for example, a 5G network. Here, the network may correspond to a server.

The autonomous vehicle may transmit specific information to the 5G network (S1). The specific information may include autonomous driving information. Then, the 5G network may determine whether or not to remotely control the vehicle (S2). The 5G network may include a server or a module which performs remote control related to autonomous driving. Then, the 5G network may transmit information (or signals) related to remote control to the autonomous vehicle (S3).

As in steps S1 and S3 of FIG. 11, to enable transmission and reception of signals and information, for example, between the autonomous vehicle and the 5G network, the autonomous vehicle may perform an initial access process and a random access process with the 5G network before step S1 of FIG. 11.

More specifically, the autonomous vehicle may perform an initial access process with the 5G network based on a synchronization signal block (SSB) to acquire downlink (DL) synchronization and system information. In the initial access process, a beam management (BM) process and a beam failure recovery process may be added, and a quasi co-located (QCL) relationship may be added when the autonomous vehicle receives signals from the 5G network.

In addition, the autonomous vehicle may perform a random access process with the 5G network to acquire uplink (UL) synchronization and/or to transmit UL data. The 5G network may transmit an UL grant for scheduling transmission of specific information to the autonomous vehicle. As such, the autonomous vehicle may transmit specific information to the 5G network based on the UL grant. Then, the 5G network may transmit a DL grant to the autonomous vehicle for scheduling transmission of a 5G processing result for the specific information. As such, the 5G network may transmit information (or signals) related to remote control to the autonomous vehicle based on the DL grant.

Next, a basic procedure of an application operation to which a method proposed in the present disclosure, which will be described below, and an ultra-reliable low latency communication (URLLC) technology of 5G communication are applied will be described.

As described above, after performing the initial access process and/or the random access process with the 5G network, the autonomous vehicle may receive a downlink preemption IE from the 5G network. Then, the autonomous vehicle may receive a DCI format 2_1 including a preemption indication from the 5G network based on the downlink preemption IE. The autonomous vehicle may not perform (or anticipate or assume) reception of eMBB data from a resource (PRB and/or OFDM symbols) indicated by the preemption indication. Thereafter, the autonomous vehicle may receive an UL grant from the 5G network when needed to transmit specific information.

Next, a basic procedure of an application operation to which a method proposed in the present disclosure, which will be described below, and a massive machine type communication (mMTC) technology of 5G communication are applied will be described.

The following description will be mainly focused on a part of the steps of FIG. 11 to be changed when the mMTC technology is applied.

In step S1 of FIG. 11, the autonomous vehicle may receive an UL grant from the 5G network to transmit specific information to the 5G network. The UL grant may include information on the number of times the transmission of specific information is repeated, and the specific information may be repeatedly transmitted based on the information on the number of repetition times. That is, the autonomous vehicle may transmit specific information to the 5G network based on the UL grant. Moreover, the repetitive transmission of specific information may be performed through frequency hopping. First transmission of the specific information may be implemented from a first frequency resource, and second transmission of the specific information may be implemented from a second frequency resource. The specific information may be transmitted through the narrowband of six resource blocks (RBs) or one RB.

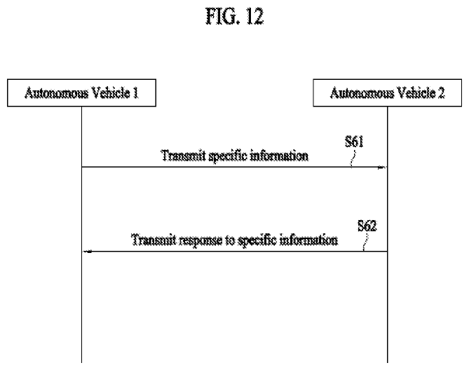

FIG. 12 is a view illustrating an example of a vehicle-to-vehicle operation using wireless communication according to an embodiment of the present disclosure. The wireless communication may include, for example, 5G wireless communication. A first vehicle may transmit specific information to a second vehicle (S61). The second vehicle may transmit a response to the specific information to the first vehicle (S62).

Note that the configuration of a vehicle-to-vehicle application operation may vary according to whether the 5G network is directly (sidelink communication transmission mode 3) or indirectly (sidelink communication transmission mode 4) involved in resource allocation of the specific information and a response to the specific information.

Next, a vehicle-to-vehicle application operation using 5G communication will be described.

First, a method in which the 5G network is directly involved in resource allocation of signal transmission and reception between vehicles will be described.

The 5G network may transmit a downlink control information (DCI) format 5A to the first vehicle for scheduling mode 3 transmission (physical sidelink control channel (PSCCH) and/or physical sidelink shard channel (PSSCH) transmission). The PSCCH may be a 5G physical channel for scheduling transmission of specific information, and the PSSCH may be a 5G physical channel for transmitting specific information. Then, the first vehicle may transmit an SCI format 1 to the second vehicle through the PSCCH for scheduling transmission of specific information. The first vehicle may also transmit specific information to the second vehicle through the PSSCH.

Next, a method in which the 5G network is indirectly involved in resource allocation of signal transmission and reception will be described.

The first vehicle may sense a resource for mode 4 transmission in a first window. Then, the first vehicle may select a resource for mode 4 transmission from a second window based on a sensing result. Here, the first window may refer to a sensing window and the second window may refer to a selection window. The first vehicle may transmit an SCI format 1 to the second vehicle through the PSCCH for scheduling transmission of specific information based on the selected resource. The first vehicle may also transmit specific information to the second vehicle through the PSSCH.

In an embodiment, the autonomous vehicle which performs at least one of V2V communication and V2X communication may transmit and receive information through a channel corresponding to the communication. For example, a sidelink channel corresponding to at least one of V2V communication or V2X communication may be allotted, and the autonomous vehicle may transmit and receive information to and from a server or another vehicle through the sidelink channel. For example, a sidelink shared channel may be allotted, and a signal for at least one of V2X communication and V2V communication may be transmitted and received through on the sidelink shared channel. In order to perform at least one of V2V communication and V2X communication, the autonomous vehicle may acquire a separate communication identifier from at least one of a base station, a network, and another vehicle. The autonomous vehicle may perform V2V or V2X communication based on the acquired identifier.

In an embodiment, broadcast information may be transmitted through a broadcast channel, and communication between nodes may be performed through a channel different from the broadcast channel. In addition, information for controlling the autonomous vehicle may be transmitted through an URLLC channel.

Although the exemplary embodiments of the present disclosure have been described in this specification with reference to the accompanying drawings and specific terms have been used, these terms are used in a general sense only for an easy description of the technical content of the present disclosure and a better understanding of the present disclosure, and are not intended to limit the scope of the present disclosure. It will be clear to those skilled in the art that, in addition to the embodiments disclosed here, other modifications based on the technical idea of the present disclosure may be implemented.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A driving state monitoring method by a computation device, the method comprising:
acquiring driving information of a vehicle;
identifying, based on the acquired driving information, whether the vehicle satisfies at least one condition in a predetermined section;
identifying a verification type corresponding to the satisfied condition; and
identifying a driving state of the vehicle based on the verification type.

2. The method of claim 1, wherein the identifying a driving state of the vehicle includes:
identifying whether there is a verification section in an expected driving route of the vehicle; and
identifying the driving state of the vehicle in the verification section using a first verification model corresponding to the verification type when there is the verification section.

3. The method of claim 2, wherein the verification type includes speed verification and steering verification, and
wherein the first verification model includes at least one of a virtual object corresponding to the verification type, a display position of the virtual object, and predicted control information of the vehicle depending on display of the virtual object, in order to perform the speed verification or the steering verification in the verification section.

4. The method of claim 3, wherein the virtual object is an object capable of causing a change in a speed of the vehicle in a case of the speed verification or an object capable of causing a change in steering of the vehicle in a case of the steering verification,
wherein the display position of the virtual object includes a position set in the verification section to allow the vehicle to secure a predetermined distance, and
wherein the predicted control information of the vehicle includes a change in the speed of the vehicle or a change in a driving distance of the vehicle depending on display of the virtual object in the verification section in the case of the speed verification, or includes a predicted distance between the vehicle and another vehicle depending on display of the virtual object in the verification section in the case of the steering verification.

5. The method of claim 4, further comprising:
comparing information on a change in the driving state of the vehicle with the predicted control information of the vehicle depending on display of the virtual object; and
controlling driving of the vehicle based on a comparison result.

6. The method of claim 5, wherein the controlling includes switching the vehicle that is under manual driving to automatic driving when the comparison result is that the information on a change in the driving state of the vehicle and the predicted control information satisfy a preset first condition, or performing driving correction on the vehicle when the comparison result is that the driving state of the vehicle and the predicted control information satisfy a preset second condition.

7. The method of claim 6, further comprising re-verifying the driving state of the vehicle using a second verification model corresponding to the verification type when a request for switching to manual driving to the vehicle is confirmed after the vehicle that is under manual driving is switched to automatic driving,
wherein the second verification model is a model in which the display position of the virtual object or the predicted control information is adjusted, compared to the first verification model.

8. The method of claim 6, wherein the vehicle that is under manual driving is switched to automatic driving when the vehicle again satisfies the at least one condition in the predetermined section after controlled to undergo driving correction.

9. The method of claim 1, wherein, in the identifying, the driving state of the vehicle is identified by comparing the driving information of the vehicle with driving information of another vehicle in the predetermined section when there is no verification section in which the driving state of the vehicle is identified.

10. A driving state monitoring method by a computation device, the method comprising:
identifying a verification type corresponding to at least one condition when a vehicle satisfies the at least one condition during traveling;
determining a first verification model corresponding to the verification type;
identifying a driving state of the vehicle using the first verification model; and
determining driving control of the vehicle based on a result of identifying the driving state.

11. A vehicle comprising:
a display; and
a processor configured to: acquire driving information of a vehicle; identify, based on the acquired driving information, whether the vehicle satisfies at least one condition in a predetermined section; identify a verification type corresponding to the satisfied condition; and identify a driving state of the vehicle based on the verification type.

12. The vehicle of claim 11, wherein the processor is configured to:
identify whether there is a verification section in an expected driving route of the vehicle; and
identify the driving state of the vehicle in the verification section using a first verification model corresponding to the verification type when there is the verification section.

13. The vehicle of claim 12, wherein the verification type includes speed verification and steering verification, and
wherein the first verification model includes at least one of a virtual object corresponding to the verification type, a display position of the virtual object, and predicted control information of the vehicle depending on display of the virtual object, in order to perform the speed verification or the steering verification in the verification section.

14. The vehicle of claim 13, wherein the virtual object is an object capable of causing a change in a speed of the vehicle in a case of the speed verification or an object capable of causing a change in steering of the vehicle in a case of the steering verification,
wherein the display position of the virtual object includes a position set in the verification section to allow the vehicle to secure a predetermined distance, and
wherein the predicted control information of the vehicle includes a change in the speed of the vehicle or a change in a driving distance of the vehicle depending on display of the virtual object in the verification section in the case of the speed verification, or includes a predicted distance between the vehicle and another vehicle depending on display of the virtual object in the verification section in the case of the steering verification.

15. The vehicle of claim 14, wherein the processor is configured to:
compare information on a change in the driving state of the vehicle with the predicted control information of the vehicle depending on display of the virtual object; and
control driving of the vehicle based on a comparison result.

16. The vehicle of claim 15, wherein the processor is configured to switch the vehicle that is under manual driving to automatic driving when the comparison result is that the information on a change in the driving state of the vehicle and the predicted control information satisfy a preset first condition, or to perform driving correction on the vehicle when the comparison result is that the driving state of the vehicle and the predicted control information satisfy a preset second condition.

17. The vehicle of claim 16, wherein the processor is configured to re-verify the driving state of the vehicle using a second verification model corresponding to the verification type when a request for switching to manual driving to the vehicle is confirmed after the vehicle that is under manual driving is switched to automatic driving, and
wherein the second verification model is a model in which the display position of the virtual object or the predicted control information is adjusted, compared to the first verification model.

18. The vehicle of claim 16, wherein the processor is configured to switch the vehicle that is under manual driving to automatic driving when the vehicle again satisfies the at least one condition in the predetermined section after controlled to undergo driving correction.

19. The vehicle of claim 11, wherein the processor is configured to identify the driving state of the vehicle by comparing the driving information of the vehicle with driving information of another vehicle in the predetermined section when there is no verification section in which the driving state of the vehicle is identified.

20. A non-volatile computer readable recording medium in which an instruction for executing the method of claim 1 in a computer is recorded.
